(19) United States
(12) Patent Application Publication
(10) Pub. No.: US 2025/0173313 A1
(43) Pub. Date: May 29, 2025

(54) Method and System for Efficient Data Searching using Complex Search Criteria

(71) Applicant: Propelr Limited, Saint Helier (JE)

(72) Inventor: Karl ANDERSON, Saint Helier (JE)

(21) Appl. No.: 18/963,947

(22) Filed: Nov. 29, 2024

(30) Foreign Application Priority Data
Nov. 29, 2023 (GB) 2318258.7

(51) Int. Cl. G06F 16/21; G06F 9/54

(52) U.S. Cl. CPC G06F 16/211; G06F 9/542

(57) ABSTRACT

There is described a computer-implemented method for generating chronologies, the method comprising: receiving one or more pieces of digital content, and for each piece of digital content: extracting core content from the piece of digital content; processing the core content using a pre-trained neural network model to extract one or more pieces of event data from the piece of digital content, the pieces of event data being linked to an event; combining a plurality of pieces of event data from the one or more pieces of digital content to generate a database of events; and generating a chronology using the database of events.

### TECHNICAL FIELD OF THE DISCLOSURE

The present disclosure relates to a method and apparatus for efficiently searching for and extracting text from a large collection of data files (for example millions of data files), where the search criteria is sufficiently complex to necessitate the use of a Large Language Model (LLM) in order to determine whether a given piece of text matches the query. The present disclosure also relates to a method for generating chronologies. More specifically, but without limitation, one aspect of the disclosure relates to a computer-implemented method for an automatic generation of chronologies from digital content.

### BACKGROUND TO THE DISCLOSURE

Across various industries, the use of chronologies has been a longstanding practice, which aims to distil and present chronological sequences of events.

The creation and utilization of chronological timelines of events holds immense value for legal practitioners. These timelines serve as an indispensable tool for capturing and conveying a legal team's comprehensive understanding of the case, documenting the sequence of significant events that have transpired, and anticipating potential future developments. The chronology aids in streamlining the proceedings and contributes to a more focused and expedient legal process.

However, the conventional approach to creating chronologies has typically been labor-intensive and time-consuming. Traditionally, professionals have relied on manual methods, involving the meticulous review of documents to extract pertinent information and the subsequent manual construction of chronologies. This manual process not only demands significant time and effort but also introduces the risk of human error.

Additionally, there exist numerous challenges associated with organizing and extracting meaningful information from diverse digital content sources. As the volume of digital content in a typical legal case continues to grow, there is an increasing need for efficient methods that can process and derive valuable insights from the available data.

Traditional approaches lack automated and systematic means for generating chronological representations of events from digital content. Existing methods may struggle with the amalgamation of a plurality of information which relate to a single event, hindering the creation of a comprehensive chronology. Furthermore, the extraction of event data linked to specific events often lacks a streamlined and scalable solution.

In addition, it is well established that database systems are capable of performing searches efficiently where the query is of a form that enables the database system to make use of indexes. For example, relational databases are capable of searching for records using criteria on those rows such as set inclusion/exclusion, numeric equality and inequality, and text pattern matching. Vector databases are capable of answering nearest-neighbor queries using HNSW indexes, and so on.

With the introduction of LLMs (Large Language Models), it has become technically feasible for a system to determine a Boolean answer to questions such as “does this text fragment contain an event”, or if the fragment does contain an event, a numerical answer to the question “on what date did the event occur”, with a high degree of accuracy.

This has created demand for database systems that can answer complex queries like “find all of the text fragments that reference an event that happened between 1996 and 2001”.

### SUMMARY OF THE DISCLOSURE

The present disclosure in one of its aspects provides a computer-implemented method and system for generating chronologies that addresses at least some of the above-mentioned limitations.

According to a first aspect of the disclosure, there is provided a computer-implemented method for generating chronologies. The method may comprise receiving one or more pieces of digital content. For each piece of digital content, the method may comprise extracting core content from the piece of digital content. For each piece of digital content, the method may comprise extracting internal metadata from the piece of digital content. For each piece of digital content, the method may comprise combining the extracted internal metadata with an external metadata of the piece of digital content to generate a complete set of metadata for the piece of digital content.

For each piece of digital content, the method may comprise processing the core content using a pre-trained neural network model to extract one or more pieces of event data from the piece of digital content. The pieces of event data may be linked to an event. The pre-trained neural-network model may comprise a pre-trained transformer model. The method may further comprise combining a plurality of pieces of event data from the one or more pieces of digital content to generate a database of events. The method may further comprise generating a chronology using the database of events.

In some embodiments, the step of processing the core content to extract the one or more pieces of event data further comprises processing both the core content and the complete set of metadata using the pre-trained neural network model.

A chronology may comprise a systematic arrangement of events or occurrences in the order in which they transpired over time. In the context of a court case, a chronology serves as a structured timeline that delineates the key events and legal proceedings related to a particular case. This chronological arrangement assists legal professionals, judges, and involved parties in comprehending the sequential unfolding of events pertinent to the case.

The computer-implemented method may be executed within a cloud-based system. Leveraging the capabilities of cloud computing enhances the scalability and accessibility of the method, allowing for the efficient processing of large volumes of digital content across diverse platforms. By harnessing the computational resources provided by cloud services, the method can be deployed and utilized remotely, offering flexibility and ease of access to users. This cloud-based implementation not only optimizes computational efficiency but also accommodates collaborative efforts, enabling multiple users to access and contribute to the generation of chronologies from various locations.

The process of receiving one or more pieces of digital content may comprise importing digital content to a system. In some embodiments, the process of receiving one or more pieces of digital content may comprise importing one or more pieces of digital content to the cloud-based system. The one or more pieces of digital content may be structured or unstructured. The one or more pieces of digital content may be imported as one or more files.

The internal metadata may comprise information embedded within a digital file or document that provides details about its content, structure, or properties. The internal metadata extracted from digital content may include information such as the creation date, authorship, version details, or any other relevant data that is inherently part of the content file. The external metadata may comprise additional information associated with a digital file or document that is stored separately from the file itself. The external metadata may comprise information like file names and/or the source of the file (e.g., the name of the file's custodian).

By processing not only the core content, but also the complete set of metadata using a pre-trained neural network model, the method ensures that relevant contextual information is not lost and that accurate pieces of event data are extracted from each piece of digital content. For example, the internal or the external metadata could contain important information as to the timing of the events. Additionally or alternatively, the internal or the external metadata could be crucial when grouping a plurality of smaller, related or equivalent events into a larger event (as will be described in more detail below).

In some embodiments, the pre-trained neural network model may comprise a large language model (LLM).

Advantageously, the disclosed method enables the generation of a chronology by utilizing the compiled database of events. This computer-implemented method offers an efficient and automated approach to organizing and presenting events derived from diverse digital content sources.

Additionally, the computer-implemented method disclosed herein significantly enhances the accuracy of generated chronologies compared to conventional manual methods. By automating the extraction of core content and metadata from digital content, the risk of human error is substantially mitigated. The method employs a pre-trained neural network model, leveraging natural language processing capabilities, to systematically process the core content and metadata. This not only ensures a more precise identification of relevant information but also facilitates a nuanced and more complete understanding of the contextual relationships within the digital content. The systematic nature of the process enhances the overall reliability and coherence of the generated chronologies. In legal cases, where precision is paramount, the increased accuracy provided by this method becomes especially valuable, ensuring that the chronology effectively captures the intricate details of the case's timeline.

The one or more pieces of digital content may comprise one or more of: an email, an image file, a text document, a spreadsheet, a written statement, a video file, an audio file, a scanned document and/or a PDF file. The skilled person would recognize that the one or more pieces of digital content may comprise any other form of digital content.

The one or more pieces of digital content may comprise the video file and the step of extracting the core content from the piece of digital content may comprise generating a transcript of the video file using a first machine learning model. The transcript may comprise information on the spoken words in the video file and/or information on the background noise in the video file and/or information on the visual content of the video file. The first machine learning model may comprise an Automatic Speech Recognition (ASR) model and/or a Deep Audio-Visual model.

The one or more pieces of digital content may comprise the audio file and the step of extracting the core content from the piece of digital content may comprise generating a transcript of the audio file using a second machine learning model. The transcript may comprise information on the spoken words in the audio file and/or information on the background noise in the audio file. In some embodiments, the second machine learning model may be the same as the first machine learning model. The second machine learning model may comprise an Automatic Speech Recognition (ASR) model, a Recurrent Neural Network (RNN) and/or other Speech-to-Text models.

The one or more pieces of digital content may comprise the image file, the scanned document or the PDF file and the step of extracting the core content from the piece of digital content may comprise applying Optical Character Recognition (OCR) software to the digital content. Additionally or alternatively, the step of extracting the core content from the piece of digital content may comprise applying object recognition software, handwriting recognition software, document layout analysis software and/or feature extraction software to the digital content.

The core content may comprise text information. Additionally or alternatively, the core content may comprise context information. The text information may comprise text which is extracted or harvested from the one or more pieces of digital content. The context information may comprise additional details surrounding the primary information extracted from a digital document. In the context of text, this includes information about the position of the text within the page, such as its page number and location on the page, as well as formatting details like font size and other stylistic attributes. Understanding the context in which the core content is situated provides valuable insights into the structure and layout of the document. This contextual information plays a crucial role in maintaining the integrity and visual representation of the original content, aiding in the accurate interpretation and organization of data extracted from digital documents.

The text information may comprise the transcript of the video file and/or the transcript of the audio file. The text information may comprise text extracted from the image file.

The one or more pieces of digital content may comprise the email, the text file or the spreadsheet and the step of extracting the core content from the piece of digital content may comprise harvesting the text information directly from the digital content. The step of extracting the core content from the piece of digital content may further comprise harvesting context information from the digital content.

Prior to processing the core content and optionally the complete set of metadata, the method may further comprise slicing the text information into two or more smaller text portions. Additionally, the method may further comprise associating one or more fragments of the context information with each of the two or more smaller text portions. Depending on the size of the text involved, the method may necessitate the segmentation of extracted text into smaller, manageable chunks as part of the preparatory processing step. The system may dynamically determine where these slices will be made, taking into account various factors. These factors may include the number of words or tokens in the text to ensure compliance with a maximum word and/or token limit in subsequent processing steps. Additionally, the system may consider contextual cues such as the position of the text on its source page, formatting characteristics, and the presence of headings or other structural elements within the text. By strategically determining where the segmentation occurs, the system ensures that each chunk maintains relevance to the whole. Context information may be associated with each sliced segment, preserving its contextual significance, and facilitating a coherent understanding of the original content during subsequent stages of analysis and processing.

Processing the core content and the complete set of metadata using the pre-trained neural network model may comprise supplying a prompt to the pre-trained neural network model. The prompt may comprise an indication of types of events to be extracted. The prompt may comprise an indication of the type of information to be extracted from each type of event. The prompt may comprise an indication of examples of the information to be extracted from each type of event.

The prompt may serve as a guiding input, instructing the neural network model on how to process and interpret the information contained within the digital content. By supplying a carefully crafted prompt, the method enhances the neural network model's efficiency in discerning relevant patterns, contextual nuances, and event-related information embedded in the core content and metadata. This approach ensures a more targeted and precise extraction of event data, contributing to the accuracy and efficacy of the overall chronology generation process.

The method may further comprise applying restrictions associated with the prompt when processing the core content using the pre-trained neural network model.

The method may further comprise receiving a request comprising a user-specified guidance. The request may comprise additional information relating to events which are to be investigated. For example, the user-specified guidance may comprise additional information relating to events which are to be investigated. The user-specified guidance may comprise additional digital content which is linked to events to be investigated. The method may further comprise determining the prompt based on the user-specified guidance.

The one or more pieces of event data may comprise a description of the event. The one or more pieces of event data may comprise time of the event. The one or more pieces of event data may comprise location of the event. The one or more pieces of event data may comprise parties involved in the event. The one or more pieces of event data may comprise entities involved in the event.

The event may comprise a meaningful occurrence extracted from digital content. This could encompass a wide range of information, such as discussions, actions, meetings, incidents or developments. Any reference to an “event” or “event data” may be replaced by a term “fact” or “fact data” in the foregoing description. This is because the disclosed method may be used to extract facts from the one or more pieces of digital content as opposed to events. The fact may comprise an objective and verifiable piece of information.

The information on parties involved in the event may comprise information on names, surnames and optionally contact information of a person or persons. The information on entities involved in the event may comprise information on companies and/or legal entities and their respective locations.

The time of the event may comprise an absolute time of the event. Additionally or alternatively, the time of the event may comprise a relative time of the event.

Absolute time may refer to the precise and unambiguous timestamp or chronological point at which an event occurred. The absolute time may be measured in units such as seconds, minutes, hours, days, and so forth, and is often associated with a specific date and time on a calendar. Examples of absolute time include Thursday 23rd November 2023 or January 2022. In contrast, relative time may describe the temporal position of an event in relation to another event or a reference point, without specifying the exact calendar time. It may be expressed in terms like “before,” “after,” “earlier,” or “later.” Examples of relative time include relative temporal statements such as “on Thursday” or “last year”.

The method may further comprise converting the relative time of the event to the absolute time of the event. Converting the relative time of the event to the absolute time of the event may comprise applying natural language processing techniques to the one or more pieces of event data. This step can make use of other context information such as other times or dates mentioned within the slice or the originating file, or the file's metadata. Converting relative time to absolute time in chronologies offers distinct advantages, including enhanced precision and clarity in event timelines. Absolute time provides unambiguous timestamps, ensuring accurate temporal representation and minimizing potential misinterpretation.

The method may further comprise analyzing the database of events to group a plurality of smaller, related or equivalent events into a larger event.

This grouping process enhances the organization and comprehension of the chronological data by consolidating events that share similarities or pertain to a common theme. Advantageously, grouping smaller events into larger ones helps eliminate redundancy in the database of events. Similar or equivalent events can be represented more concisely, streamlining the overall presentation of the chronology, and allowing the user to more easily navigate the database of events. Additionally, grouping events allows for a more effective analysis of patterns and relationships within the data. It facilitates the identification of recurring themes, milestones, or significant developments over time. Additionally, for users navigating the chronology, the grouping of events simplifies the process of locating and understanding information. It provides a more intuitive structure, aiding in efficient information retrieval.

Grouping the plurality of smaller, related, or equivalent events into the larger event may comprise producing a set of potentially matching events. Producing a set of potentially matching events may comprise searching the plurality of pieces of event data for potentially matching events using fuzzy string matching and embedding information. Additionally or alternatively, producing a set of potentially matching events may comprise identifying similar times of the events in the database of events. Additionally or alternatively, producing a set of potentially matching events may comprise using metadata or context information to identify and group related or equivalent events. Identifying similar times of the events in the database of events may comprise identifying that the events occurred within a specific time period. For example, identifying similar times of the events in the database of events may comprise identifying that the events occurred within a few seconds, a few hours, or a few days of each other. In some embodiments, provisions may be made for the time information being approximate, incomplete, or absent.

Producing a set of potentially matching events may further comprise, for each set of potentially matching events determining whether the events are related or equivalent using a third machine learning model. Producing a set of potentially matching events may further comprise upon determining that the events are related, identifying a type of relationship between the events using the third machine learning model.

The third machine learning model may comprise a Siamese Neural Network architecture, Recurrent Neural Network (RNN) and/or a Transformer-based Model.

Identifying the type of relationship between events may comprise a crucial step in contextualizing and organizing information extracted from various sources. For instance, an “event” may comprise an individual expressing an inability to attend an “upcoming board meeting on Thursday” in an email. In this scenario, the system may determine a relationship to a calendar invitation for the meeting, characterized as a “response regarding attendance.” Subsequent events, such as additional emails discussing the meeting, the issuance of board minutes, and their subsequent approval, may also be extracted using the outlined procedures. These events may collectively contribute to the formation of a larger, cohesive event centered around the Thursday board meeting.

The method may further comprise providing a visual representation of the chronology. Providing the visual representation of the chronology may comprise generating a list, a timeline, a fishbone diagram and/or a knowledge graph based on the chronology.

The method's provision of a visual representation of the chronology offers several notable benefits. For example, the visual representation aids in identifying patterns, trends, and dependencies within the chronology, contributing to more informed decision-making. Additionally, the method's visual representation enhances the usability, interpretability, and communicative efficacy of the chronology, making it an asset in diverse applications such as legal proceedings, or project management.

The method may further comprise filtering the chronology by: a type of event, parties involved in the event, a location of the event, a time range within which the one or more events took place, and/or a keyword.

The method's capability to filter the chronology based on various criteria allows for a streamlined information retrieval. Additionally, this feature supports trend analysis and assists in uncovering patterns within the data. Overall, the filtering functionality enhances the method's adaptability and usability.

The method may further comprise attaching a reference to each event in the chronology. The reference may connect each event to the one or more pieces of digital content. The reference may comprise a hyperlink to the one or more pieces of digital content. Additionally, or alternatively the reference may comprise Document Identifiers (e.g., document names, IDs, or references), file paths, metadata tags, document citations and/or QR codes.

The combination of the chronology with integrated references to one or more pieces of digital content essentially provide a database management system. This data management system is configured to store and retrieve data using various data structures for efficient management of data.

The method may further comprise manually adding, removing, reordering, and/or amending one or more of the events in the chronology. This customizable approach may allow for tailoring the chronology to specific needs, ensuring relevance and alignment with user objectives. The manual intervention facilitates accuracy by correcting errors and updating information in dynamic scenarios. Users can enhance the contextual relevance of the timeline by reordering events and focusing their analysis on specific aspects, supporting a more efficient exploration of data.

A further aspect of the disclosure provides a computer program. The computer program may comprise instructions which, when the program is executed by a computer, cause the computer to perform any of the methods disclosed herein.

A further aspect of the disclosure provides a computer-readable medium. The computer readable medium may comprise instructions that, when executed by one or more processors, cause an apparatus comprising the one or more processors to perform any of the methods disclosed herein.

The skilled person will appreciate that except where mutually exclusive, a feature described in relation to any one of the aspects, examples or embodiments described herein may be applied to any other aspect, example, embodiment or feature. Further, the description of any aspect, example or feature may form part of or the entirety of an embodiment of the disclosure as defined by the claims. Any of the examples described herein may be an example which embodies the disclosure defined by the claims and thus an embodiment of the disclosure.

The present disclosure, in another one of its aspects, provides a computer-implemented method and system for enabling complex search queries to be used on large data sets of records or files in an efficient manner that addresses at least some of the above-mentioned limitations.

The present disclosure provides a system comprising a searchable data index, the searchable data index comprises: a pointer to an original text fragment, such that the system can efficiently find the text fragment when responding to a user query on the index, and potentially show the text fragment in the context of the original source document; an LLM-generated embedding vector of the source text fragment; and answers to each of a plurality of determinative questions. These determinative questions can be expressed as a complex query.

In this regard, the system effectively pre-calculates the results of expensive data processing calculations, and then builds a regular index over those results such that they can be searched efficiently. The data processing calculations are necessary and expensive as they handle complex queries which provide the determinative questions.

### BRIEF DESCRIPTION OF THE DRAWINGS

In order that the disclosure may be more clearly understood one or more embodiments thereof will now be described, by way of example only, with reference to the accompanying drawings, of which:

FIG. 1 is a schematic diagram of a system for generating chronologies;

FIG. 2 is a schematic diagram of the server shown in FIG. 1;

FIG. 3a is flow diagram of a method of generating chronologies;

FIG. 3b is a continuation of the flow diagram of the method of generating chronologies;

FIG. 4 is a schematic flow diagram of a second embodiment of the present disclosure which can generate or populate a timeline; and

FIG. 5 is a schematic flow diagram of a third embodiment of the present disclosure which is directed to the efficient creation of an index for us in efficient extraction of text from a large collection of data files using a complex search query.

### DETAILED DESCRIPTION OF EMBODIMENTS OF THE DISCLOSURE

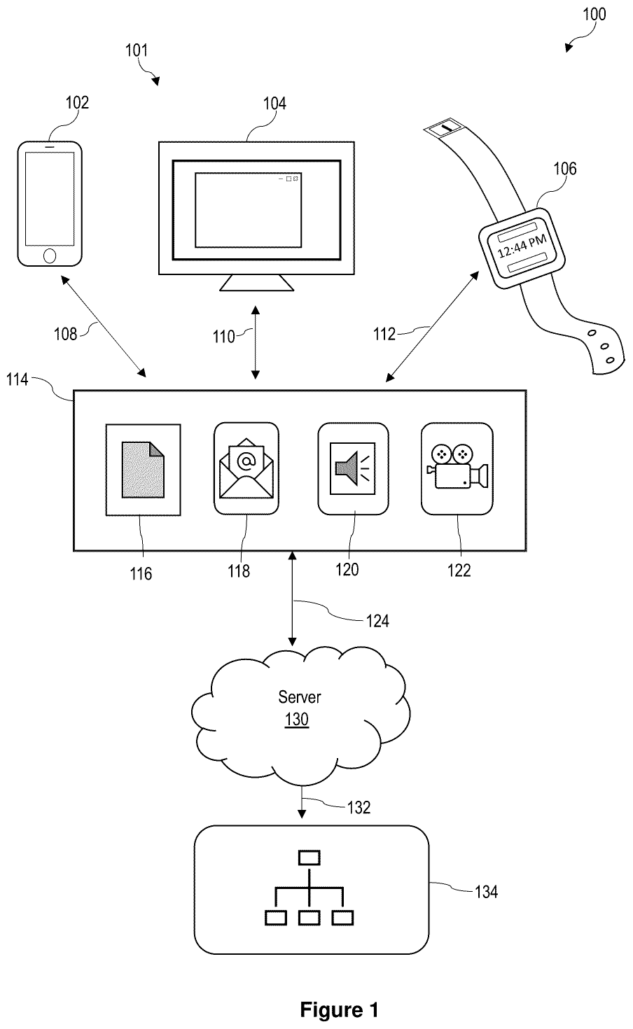

FIG. 1 is a schematic diagram of an example of a system 100 for generating chronologies. The system comprises sources of digital content 101, a plurality of pieces of digital content 114, a server 130 and a generated chronology 134.

The sources of digital content 101 comprise a mobile device 102, a computer 104 and a wearable device 106 in the form of a smart watch. Although only three specific sources of digital content 101 are portrayed in FIG. 1, the sources of digital content may comprise any number of any suitable type of computing devices. For example, the sources of digital content 101 may comprise one or more of: a tablet computer, a laptop computer, a computer located within an automobile, a camera, a video camera, a smart doorbell, a smart TV, and/or any wearable device (e.g., a VR headset).

The terms “server” and “mobile device” are intended only to facilitate identification and should not be taken to imply any limitations or requirements on the form or capabilities of those devices. Although only one server 130 is shown in FIG. 1, the disclosed functionality of the server 130 may be achieved by a plurality of servers. Such a plurality of servers may, or may not, be located at geographically distinct locations, and the disclosed functionality of the server 130 may be distributed between those servers in any suitable manner. In other embodiments, the methods implemented by the server 130 may be carried out be a computer.

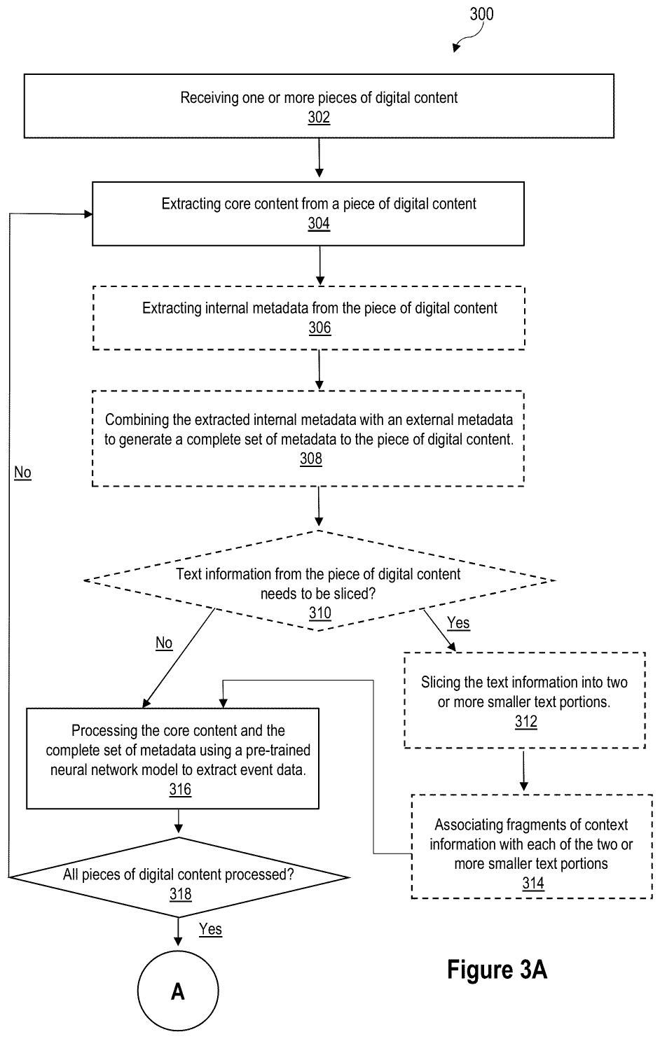

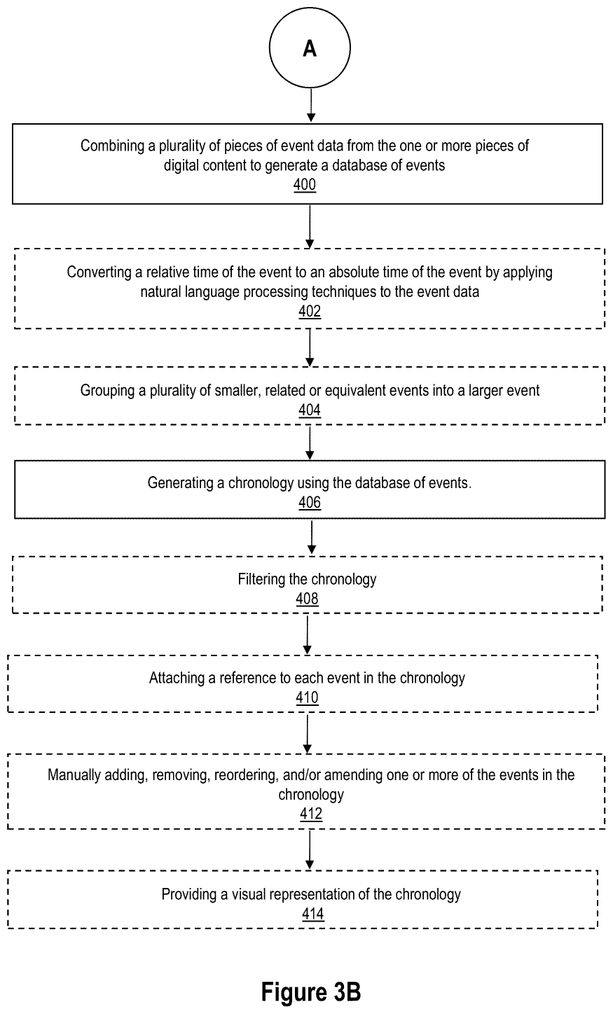

The server 130 may comprise a component of cloud computing infrastructure or as a physical server. In the context of cloud computing, the server operates within a virtualized and scalable environment, offering advantages such as flexibility, resource optimization, and on-demand scaling. Cloud computing allows the method to harness computational power, storage, and other services without the constraints of physical hardware limitations. Furthermore, cloud environments enable seamless collaboration, accessibility from various locations, and robust data security measures, enhancing the overall efficiency and reliability of the method disclosed with reference to FIGS. 3A and 3B.

The plurality of pieces of digital content 114 comprise a text document 116, an email 118, an audio file 120 and a video file 122. Although not shown for the sake of simplicity the plurality of pieces of digital content 114 may comprise any number of pieces of digital content. Additionally, the one or more pieces of digital content 114 may comprise any other form of digital content. For example, the plurality of pieces of digital content 114 may additionally or alternatively comprise an image file, a spreadsheet, a written statement, a scanned document and/or a PDF file. The plurality of pieces of digital content 114 may comprise structured or unstructured data.

The generated chronology 134 may be presented in any form. For example, the chronology 134 may be presented to the user as a list, a timeline, a fishbone diagram and/or a knowledge graph. A person skilled in the art would recognize that other forms of presenting the generated chronology 134 to a user are available.

The plurality of pieces of digital content 114 may be communicated to the server 130 over various communication paths. For example, the plurality of digital content is communicated from the mobile device 102 to the server 130 via a first communication path comprising a first communication link 108 and a second communication link 124. In this embodiment, the plurality of digital content is communicated from the computer 104 to the server 130 via a second communication path comprising a third communication link 110 and the second communication link 124. Additionally, in this embodiment, the plurality of digital content is communicated from the wearable device 106 to the server 130 via a third communication path comprising a fourth communication link 112 and the second communication link 124. The skilled person would appreciate that any other communication paths may be used to communicate data from the sources of digital content 101 to the server 130.

The server uses a fifth communication link 132 to communicate the chronology 134 to the user. For example, the fifth communication link 132 may link the server 130 to a user device (e.g. any computing device). The user device may be configured to convey the chronology 134 to a user in any suitable manner e.g., via a visual display, an audio description or similar.

The first communication link 108, the second communication link 124, the third communication link 110, the fourth communication link 112 and/or the fifth communication link 132 may comprise a wired or a wireless connection link.

The wired connection link may comprise a physical cable or wire. For example, the wired connection link may comprise coaxial cables or fiber-optic cables. The wired connection link offers a reliable and secure data transfer connection.

The wireless connection link may comprise a wide-area network communication link. The wide-area network communication link may comprise a cellular telephone network, a Wi-Fi network or a combination thereof. Additionally, or alternatively, the wireless connection link may comprise a short-range wireless communication link. The short-range wireless communication link may comprise a radio frequency communication link and/or a Bluetooth™ communication link.

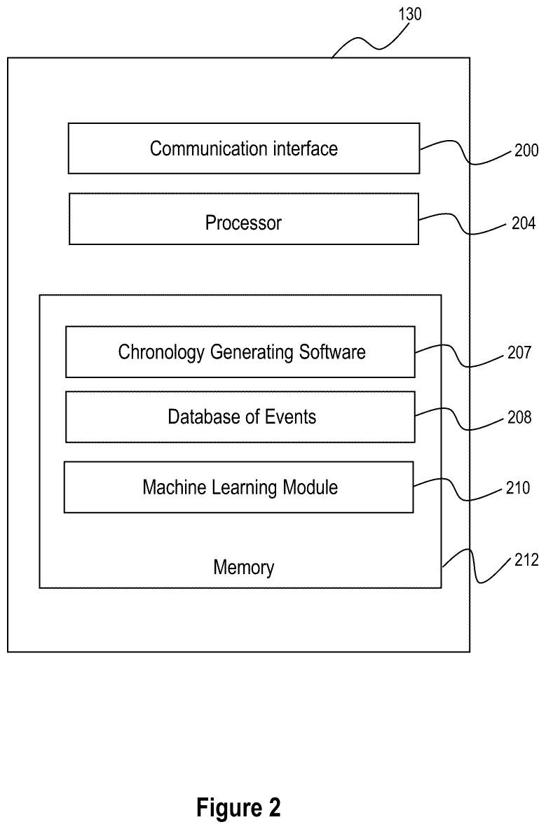

FIG. 2 is a schematic diagram of the server 130 shown in FIG. 1. The server 130 comprises a communication interface 200, a processor 204 and a memory 212. The memory 212 comprises a chronology generating software 207, a database of events 208 and a machine learning module 210. The server 130 may comprise other components (not shown for the sake of simplicity) typically present in general purpose servers.

The memory 212 stores information accessible by the processor 204, including instructions and data that may be executed or otherwise used by the processor 204. The memory 212 includes processor-executable instructions that, when executed by the processor 204, cause the server 130 to perform, or assist in performing, any of the methods described with reference to FIG. 3A or FIG. 3B.

The memory 212 may be of any type capable of storing information accessible by the processor 204, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The processor 204 may be any conventional processor, such as a microprocessor or a microcontroller. Alternatively, the processor may be a dedicated device such as an ASIC. Although FIG. 2 functionally illustrates the processor 204, the memory 212, and the communication interface 200 as being within the same block, it will be understood by the person skilled in the art that the processor and memory may actually comprise multiple processors and memories that may or may not be stored within the same physical housing. For example, rather than being stored in the same server, processor 204 and memory 212 may be stored in separate devices.

The communication interface 200 may comprise one or more wireless transmitters and receivers, to communicate with the sources of digital content 101 over various types of networks. Additionally or alternatively, the communication interface 200 may be configured to control the exchange of data over the first communication link 108, the second communication link 124, the third communication link 110, the fourth communication link 112 and/or the fifth communication link 132.

The chronology generating software 207 serves as the engine orchestrating the organization and sequencing of events. The chronology generating software comprises computer-readable instructions that when executed are configured to carry out the method steps described with reference to FIGS. 3A and 3B.

The database of events 208 functions as a repository, storing one or more pieces of event data which have been extracted from one or more pieces of digital content 114 (as will be described further with reference to FIGS. 3A and 3B).

The pieces of event data are each linked to one or more events. The one or more pieces of event data comprise a description of the event, time of the event, location of the event, details on parties involved in the event and/or entities involved in the event.

The event may comprise a meaningful occurrence extracted from the one or more pieces of digital content 114. This could encompass a wide range of information, such as discussions, actions, meetings, incidents, or developments. Any reference to an “event” or “event data” may be replaced by a term “fact” or “fact data” in the foregoing description. This is because the disclosed method may be used to extract facts from the one or more pieces of digital content 114 as opposed to events. The fact may comprise an objective and verifiable piece of information.

The information on parties involved in the event may comprise information on names, surnames and optionally contact information of a person or persons. The information on entities involved in the event may comprise information on companies and/or legal entities and their respective locations.

The time of the event may comprise an absolute time of the event (for example, precise and unambiguous timestamp or chronological point). Additionally or alternatively, the time of the event may comprise a relative time of the event (for example, a temporal position of an event in relation to another event or a reference point).

Integrated machine learning module 210 comprises various machine learning models which includes a pre-trained neural network model. The integrated machine learning module 210 may further comprise one or more of: an Automatic Speech Recognition (ASR) model and/or a Deep Audio-Visual model and/or a Recurrent Neural Network (RNN) and/or a Speech-to-Text model and/or a Siamese Neural Network architecture. The machine learning models contribute advanced analytical capabilities, enabling the extraction of nuanced event data and the identification of meaningful patterns within the chronology. FIGS. 3A and 3B show a flow diagram of a method 300 of generating chronologies. The method 300 may be carried out by the server 130.

The method begins at block 302, in which the server receives the one or more pieces of digital content 114. As described with reference to FIG. 1, the one or more pieces of digital content 114 may be captured by the one or more sources of digital content 101 (e.g., the mobile phone 102, the computer 104 and/or the wearable device 106). The one or more pieces of digital content may comprise the text document 116, the email 118, the audio file 120 and/or the video file 122. The server 130 may receive the one or more pieces of digital content 114 over the first communication link 108, the second communication link 124, the third communication link 110, and/or the fourth communication link 112. The process of receiving the one or more pieces of digital content 114, may comprise importing the one or more pieces of digital content 114 by the server 130. The one or more pieces of digital content may be imported as one or more distinct files.

Optionally, at block 304, the server 130 extracts core content from a piece of digital content. For example, at this step the server 130 may extract core content from a first piece of digital content. The core content comprises text information and optionally context information. The text information comprises text which is extracted or harvested from the one or more pieces of digital content 114. The context information comprises additional details surrounding the primary information extracted from the digital content 114. In the context of text, context information includes information about the position of the text within the page, such as its page number and location on the page, as well as formatting details like font size and other stylistic attributes.

Advantageously extracting the context in which the text is situated provides valuable insights into the structure and layout of the document. This contextual information plays a crucial role in maintaining the integrity and visual representation of the original content, aiding in the accurate interpretation and organization of data extracted from digital content 114.

The exact process involved in extracting the core content from a piece of digital content 114 will depend on the specific type or format of the digital content 114.

For example, if the piece of digital content 114 comprises the video file 122, the step 304 of extracting the core content from the piece of digital content 114 comprises generating a transcript of the video file 122 using a first machine learning model. The transcript may comprise information on the spoken words in the video file 122 and/or information on the background noise in the video file 122 and/or information on the visual content of the video file 122. The first machine learning model may comprise an Automatic Speech Recognition (ASR) model and/or a Deep Audio-Visual model. The first machine learning model may be stored in the machine learning module 210 within the server 130.

If the piece of digital content 114 comprises the audio file 120, the step 304 of extracting the core content from the piece of digital content 114 comprises generating a transcript of the audio file 114 using a second machine learning model. The transcript may comprise information on the spoken words in the audio file 114 and/or information on the background noise in the audio file 114. In some embodiments, the second machine learning model may be the same as the first machine learning model. The second machine learning model may comprise an Automatic Speech Recognition (ASR) model, a Recurrent Neural Network (RNN) and/or other Speech-to-Text models. The second machine learning model may be stored in the machine learning module 210 within the server 130.

If the piece of digital content 114 comprises the email 118 or the text file 116, the step 304 of extracting the core content from the piece of digital content 114 comprises harvesting the text information directly from the digital content 114.

The skilled person will appreciate that for other types of files (e.g., image files, spreadsheet files and/or scanned documents etc.), other tools and techniques are chosen as appropriate to ensure that the core content is extracted from the piece of digital content 114.

Optionally, at block 306, the server 130 extracts internal metadata from the piece of digital content 114. The method of extracting the internal metadata comprises standard techniques relevant to the file format. The internal metadata comprises information embedded within a digital file or document (i.e., the digital content 114) that provides details about its content, structure, or properties.

Optionally, at block 308, the server 130 combines the extracted internal metadata with an external metadata of the piece of digital content 114 to generate a complete set of metadata for the piece of digital content 114. The external metadata comprises additional information associated with a digital file or document (i.e., the digital content 114) that is stored separately from the file itself.

In some embodiments, at block 310, the server 130 may decide whether the text information from the piece of digital content 114 needs to be sliced. The decision as to whether the text information needs to be sliced may depend on the size of the text involved. In other words, the server 130 may decide that the text information needs to be sliced before the next step due to its size.

If the server 130 decides that the text information from the piece of digital content 114 needs to be sliced, the method 300 proceeds to block 312.

At block 312, the server slices the text information into two or more smaller text portions. The server 130 decides where the slices will be made. The server 130 considers the number of words or tokens in the text (in order to ensure that a maximum word or token limit is not breached in the next step), and/or the position of the text on its source page, and/or its formatting, and/or the use of headings and other structural elements within the text. In some embodiments, a user may apply a semantic similarity criterion to dictate that the text should be sliced when a pre-determined threshold is crossed in an embedding space (which corresponds to new topics being introduced in the text).

At block 314, the server 130 associates fragments of context information with each of the two or more smaller text portions. In this manner, the relevance of the context to the whole piece of digital content 114 is retained. Sometimes, no slicing is necessary, and the extracted text information from the piece of digital content 114 can be passed on to the next block 316 as a whole.

After block 314 or if the server 130 decides that the text information from the piece of digital content 114 does not need to be sliced, the method 300 proceeds to block 316.

At block 316, the server 130 processes the core content and optionally the complete set of metadata using a pre-trained neural network model to extract one or more pieces of event data from the piece of digital content 114, the pieces of event data being linked to an event. The pre-trained neural network model comprises a large language model (LLM) or a transformer model. The pre-trained neural network model is stored in the machine learning module 210 within the server 130.

By processing not only the core content, but also the complete set of metadata using the pre-trained neural network model, the method 300 ensures that relevant contextual information is not lost and that accurate pieces of event data are extracted from each piece of digital content 114. For example, the internal or the external metadata could contain important information as to the timing of the events.

The step 316 could comprise supplying a prompt to the pre-trained neural network model. The prompt may comprise an indication of types of events to be extracted. The prompt may comprise an indication of the type of information to be extracted from each type of event. The prompt may comprise an indication of examples of the information to be extracted from each type of event. The prompt may comprise a reference body of documents that indicates the types of events to be extracted or investigated. Alternatively, the prompt may comprise a specific indication of the types of events to be extracted or investigated. Generating this specific indication may comprise providing a body of reference documents to a neural network. Generating this specific indication may further comprise the neural network extracting the core content from the body of reference documents. Generating this specific indication may further comprise the neural network processing the core content of the body of reference documents to generate the specific indication.

The prompt may serve as a guiding input, instructing the neural network model on how to process and interpret the information contained within the digital content 114. By supplying a carefully crafted prompt, the method enhances the neural network model's efficiency in discerning relevant patterns, contextual nuances, and event-related information embedded in the core content and metadata. Additionally, by supplying or utilizing the body of documents that indicates the types of events to be extracted or investigated, the events which are ultimately extracted are more relevant and accurate.

In some embodiments (not shown), the method 300 may comprise receiving a request comprising a user-specified guidance, the request comprising additional information relating to events which are to be investigated. The method may further comprise determining the prompt based on the user-specified guidance. The request comprising a user-specified guidance may comprise an argument or a situation or types of events that the user is seeking to prove or investigate, in worded form. The system takes this wording, and through a further LLM (or other neural network model) integration, provides a suitable prompt that can be used to find relevant events and/or pieces of digital content.

The output of step 316 comprises a series of events, including descriptions of what happened, who was involved (the “parties”), facts of the case, and potentially time information in absolute or relative terms.

At block 318, the server 130 determines if all of the pieces of digital content 114 have been processed. If not all of the pieces of digital content 114 have been processed, the server is configured to repeat steps 304 to 316 for each piece of digital content 114 received by the server 130. For example, the server 130 may be configured to repeat steps 304 to 316 for a second, a third and a fourth (and so on) piece of digital content 114. If all of the pieces of digital content 114 have been processed the method 300 proceeds to method blocks shown in FIG. 3B.

At block 400, the server 130 combines the plurality of pieces of event data from the one or more pieces of digital content 114 to generate the database of events 208. The database of events 208 is stored in the memory 212 of the server 130. The database of events 208 may be continuously dynamically modified or extended.

Optionally, at block 402, the server 130 converts any relative times associated with any of the extracted events to a corresponding absolute time. In some embodiments the server 130 doesn't detect any relative times in the extracted pieces of event data and this step can be omitted. Converting the relative time of the event to the absolute time of the event may comprise applying natural language processing techniques to the one or more pieces of the extracted event data. This step can make use of other context information such as other times or dates mentioned within the slice or the originating file, or the file's metadata. Converting relative time to absolute time in chronologies offers distinct advantages, including enhanced precision and clarity in event timelines. Absolute time provides unambiguous timestamps, ensuring accurate temporal representation and minimizing potential misinterpretation.

Optionally, at block 404, the server 130 analyses the database of events 208 to group a plurality of smaller, related or equivalent events into a larger event.

This grouping process enhances the organization and comprehension of the event data by consolidating events that share similarities or pertain to a common theme.

Advantageously, grouping smaller events into larger ones helps eliminate redundancy in the database of events 208. Similar or equivalent events can be represented more concisely, streamlining the overall presentation of the chronology and allowing the user to more easily navigate the database of events 208. Additionally, grouping events allows for a more effective analysis of patterns and relationships within the data. It facilitates the identification of recurring themes, milestones, or significant developments over time.

Grouping the plurality of smaller, related or equivalent events into the larger event comprises two stages.

The first stage involves producing a set of potentially matching events. Producing a set of potentially matching events comprises searching the plurality of pieces of event data for potentially matching events using fuzzy string matching and embedding information. Producing a set of potentially matching events may further comprise identifying similar times of the events in the database of events 208. Additionally or alternatively, producing a set of potentially matching events may comprise using metadata or context information to identify and group related or equivalent events.

Identifying similar times of the events in the database of events involves identifying that the events occurred within a specific time period. For example, identifying similar times of the events in the database of events 208 may comprise identifying that the events occurred within a few seconds, a few hours, or a few days of each other. Provisions may be made for the time information being approximate, incomplete, or absent.

In the second stage, for each set of potentially matching events, the server 130 determines whether the events are related or equivalent using a third machine learning model. Upon determining that the events are related, the server identifies a type of relationship between the events using the third machine learning model. For example, the relationship might be that an “event” where someone indicated in an email that they could not attend the “upcoming board meeting on Thursday” is determined to have a relationship to a calendar invitation to the meeting itself, and that the relationship is “response regarding attendance”. In this example, later emails about the meeting, and the issuance of the board minutes and their subsequent approval, also count as events that are extracted using the procedures described in the preceding steps and will ultimately be grouped into one larger event about the Thursday board meeting.

The third machine learning model may comprise a Siamese Neural Network architecture, Recurrent Neural Network (RNN) and/or a Transformer-based Model. The third machine learning model is stored in the machine learning module 210.

At block 400, the server 130 generates the chronology 134 using the database of events 208. Generating the chronology 134 using the database of events 208 entails the process of organizing and presenting the events in a temporal sequence, often involving a step of reordering them based on the time of their occurrence. This temporal reordering ensures that the resulting chronology accurately reflects the chronological flow of events over time. By arranging events in a systematic order, users can comprehend the progression of activities, developments, or incidents within a specific timeframe.

Optionally, at block 408, the server 130 may be configured to filter the chronology 134 by: a type of event, parties involved in the event, a location of the event, a time range within which the one or more events took place, and/or a keyword. This may aid a user in quickly extracting important information from the chronology 134.

Optionally, at block 410, the server 130 may attach a reference to each event in the chronology 134. The reference connects each event to the one or more pieces of digital content 114. The reference may comprise a hyperlink to the one or more pieces of digital content 114. Additionally, or alternatively the reference may comprise document identifiers (e.g., document names, IDs, or references), file paths, metadata tags, document citations and/or QR codes.

Optionally, at block 412, the server 130 may allow a user to manually add, remove, reorder, and/or amend one or more of the events in the chronology 134.

Optionally, at block 414, the server 130 may provide a visual representation of the chronology 134 to the user. The visual representation of the chronology 134 may comprise a list, a timeline, a fishbone diagram and/or a knowledge graph. The visual representation may be provided to the user via a user equipment (the mobile device 102, the computer 104 and/or the wearable device 106). Optionally, the user can choose to export the visual representation of the chronology 134 as a text document, a PDF document, a spreadsheet, or in another format.

In some embodiments, the user can choose to share the database of events 208 and/or the visual representation of the chronology 134 with other parties. Optionally, the system provides a way for users to apply custom metadata or custom labels to events in the database of events 208.

The method 300 disclosed herein offers several advantages over conventional methods of generating chronologies. For example, no current technologies provide a method for automatically determining events and automatically populating timelines from unstructured data in pieces of digital content 114. The described computer-implemented method 300 offers an efficient and automated approach to organizing and presenting events derived from diverse digital content sources 101. Additionally, the method 300 disclosed herein significantly enhances the accuracy of generated chronologies compared to conventional manual methods.

It will be understood that the present disclosure is not limited to the examples and embodiments above described and various modifications and improvements can be made without departing from the concepts described herein. Except where mutually exclusive, any of the features may be employed separately or in combination with any other features and the disclosure extends to and includes all combinations and sub-combinations of one or more features and embodiments described herein.

Although the computer-implemented method for generating the chronologies has been described with reference to specific applications in the regulatory or legal industry, it should be appreciated that the method can be used in other contexts and industries. For example, the method disclosed herein can be used in project management (e.g. For post implementation reviews for engineering projects), contract review, or when conducting due diligence in a range of industries.

The methods shown in FIGS. 3A and 3B can be performed by instructions stored on a processor-readable medium. The processor-readable medium may be: a read-only memory (including a PROM, EPROM or EEPROM); random access memory; a flash memory; an electrical, electromagnetic or optical signal; a magnetic, optical or magneto-optical storage medium; one or more registers of a processor; or any other type of processor-readable medium. In alternative embodiments, the present disclosure can be implemented as control logic in hardware, firmware, software or any combination thereof.

Additionally, the sequence of operations shown in FIGS. 3A and 3B are merely exemplary. Any of the operations shown in the method 300 may be performed in a different order that achieves substantially the same result.

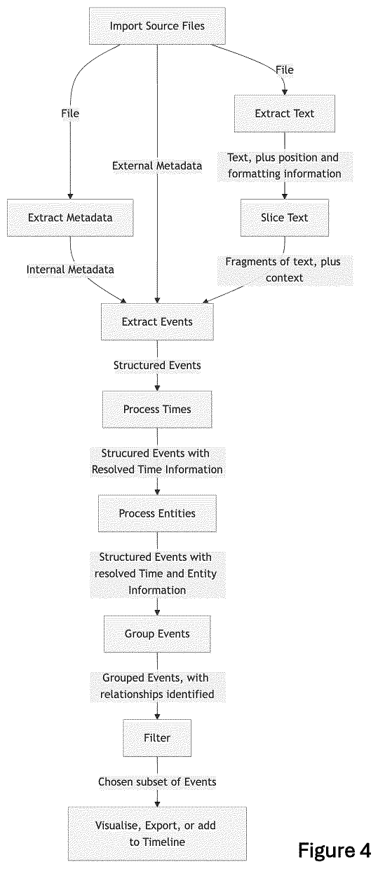

Referring now to FIG. 4, there is shown a second embodiment of the present disclosure. The second embodiment operates using the same structures as described with the first embodiment but provides more detail on how the database is constructed. The steps of creating structured events, then creating structured events resolved with time information and finally, creating structured events resolved with time information and entity information, are steps carried out before potentially grouping the events together.

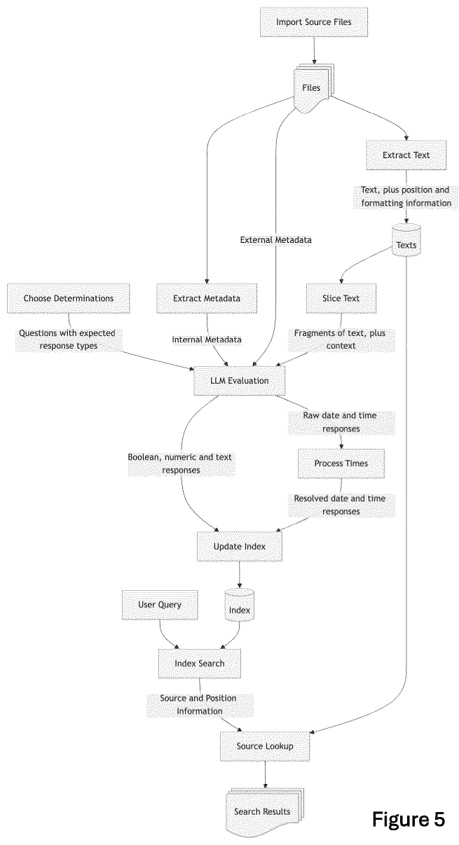

Referring now to FIG. 5, there is shown a third embodiment of the present disclosure. The third embodiment operates using the same structures as described with the first and second embodiments save for the differences described below. In particular, the third embodiment uses a specifically constructed index which enables faster more efficient complex searching to be carried out when using an LLM.

It is appreciated that the determinative questions and the complex query mentioned previously depend on meaning and therefore appear to have a cognitive element, but it is noted that such determinations are performed by a sub-system (the LLM) that is not by itself not part of the innovation. The LLM, for which there are several competing implementations, may be treated as a black box. This embodiment of the present disclosure, is directed to a mechanism of making better use of that black box, such that user queries can be processed efficiently for very large numbers of records. The implementation of the black box (the LLM sub-system) is irrelevant. It is noted that the black box is solely implemented through the evaluation of mathematical operations within computing devices. In this regard, the LLMs have no actual understanding of the concepts being represented, nor any need for any such understanding. They, and this embodiment, are meaning-agnostic.

It is also unimportant that the query might relate to events specifically, it is only important that the query is one that is sufficiently complex to require the use of an LLM and the technology described in this embodiment to evaluate the query, thus implying the need for a search system to make use of an LLM.

Whilst LLM systems are capable of determining answers to the above questions by supplying text fragments and a query to an instruction-tuned LLM, or by supplying only the text to a fine-tuned LLM, in the case that the query is known in advance, they suffer from limitations. Most importantly, the scalability of this approach is limited, in that LLM sub-systems can only process finite and relatively small amounts of text at a time. These limits are expressed in numbers of “tokens”, which limit the number of words that the text can contain. Although context window limits have increased over time and will continue to increase, this limitation makes it infeasible to apply user queries to large numbers of files using this technique.

In cases where a user wants to search for all documents (or all text records) containing (for example) events, a hypothetical system could process each record separately, using the LLM sub-system for each record to determine whether the fragment matches the query. This approach is inefficient. In cases where there are millions of records, each taking 10-250 ms to process, individual user queries can easily take multiple hours or days. These queries can also entail significant network traffic for each query, in the common case where the LLM sub-system is not co-located.

It is also well known that techniques such as Retrieval Augmented Generation (RAG) can be applied to avoid the need to process all records within each search. In RAG, a pre-generated index of LLM-derived embedding vectors is constructed. This enables a subset of files to be identified that are relevant to a given query. The subset is typically selected using distance metrics in the embedding vector space. This indexing approach allows a much larger number of files to be interrogated but has the limitation that the query is evaluated only on a subset of documents chosen using those embedding vectors, not on the entire set of files. This approach to scaling query evaluation is therefore not an adequate solution for searching large sets of files using complex queries.

The present embodiment provides a solution for processing complex queries to search large sets of files. At the heart of the process is an indexing process which is described below and is expressed in FIG. 5.

A user chooses which determinations should be made in respect of each text fragment that they wish to query, possibly in the form of a determinative question and the data type of the expected answer. For example, assuming that the user wishes to search efficiently for events by date, they may choose to define “does this text refer to an event”, with an expectation of a Boolean response, and “on what date did the event occur” with the expectation of a date/time response. The determinative questions themselves are arbitrary, and not important to the implementation of this embodiment; it is only important that these questions are resolvable by the LLM sub-system.

The user imports information in electronic form to the system. This information could include email, documents, spreadsheets, reports, statements, video, audio material, scans, or anything else. The information may be structured or unstructured. It is imported as one or more files.

The system, using known techniques, extracts text from each file using methods that vary depending on the file's format. Where the source file is pre-formatted (such as for a PDF file), the position of the text within the page (e.g. its page number and location on the page) and its font size (e.g. font size), and other formatting information, is also extracted, to aid interpretation in later steps. This is important because positioning, font sizes, and formatting sometimes carry information that is relevant to the interpretation of the material.

The following sets out the different types of extraction process which can be used:
For image files, OCR is applied;
For PDF files, embedded text is extracted and/or OCR is applied, according to pre-defined heuristics;
For documents, spreadsheets, and email formats, the embedded text is extracted directly;
For video files, AI services are used to generate transcripts of the video;
For audio files, AI services are used to extract a text description of the audio, including the words spoken and a worded description of other sounds;
For other types of files, tools and techniques are chosen as appropriate to the format.

The system extracts internal metadata from the files, using standard techniques relevant to the file format. The internal metadata is combined with any external metadata, such as file names, the source of the file (such as the name of its custodian), producing a complete set of metadata for each file. The purpose of the metadata is to allow the determinative questions to make use of the metadata.

Optionally, depending on the size of the text involved, and in response to the fixed or dynamic limitations of the underlying LLM, the system slices the extracted text into smaller chunks in preparation for the next step. The system chooses where the slices will be made. The system considers the number of words or tokens in the text (in order to ensure that a maximum word or token limit is not breached in the next step), and/or the position of the text on its source page, and/or its formatting, and/or the use of headings and other structural elements within the text. Where this slicing occurs, the system associates context information with each fragment so that its relevance to the whole is retained. Sometimes, no slicing is necessary, and the extracted text can be passed on to the next step as a single fragment.

The system processes each text fragment, and any metadata associated with the source file using the LLM, together with a prompt that instructs the LLM to answer the determinative questions, producing Boolean, numeric, and text properties from the fragment. This step can be achieved using a general-purpose LLM such as OpenAI's GPT with a custom prompt or using a fine-tuned or specifically trained model.

Optionally, in the case of date/time properties, the system applies natural language processing techniques (or potentially a further LLM pass, or potentially text matching) to resolve references to dates and times within the output, and applies a series of heuristics to convert relative times (like “on Thursday” or “last year”) to absolute times (like “Thursday 23rd November 2023” or “2022”). This step can make use of other context information such as other times or dates mentioned within the slice or the originating file, or the file's metadata. The benefit of capturing and resolving dates and times during the indexing process is that it enables date-related queries to be resolved efficiently, avoiding individual interrogation of either the partially constrained results or the full database.

These properties are then used to create an index that comprises: a pointer to the original text fragment, such that the system can efficiently find the text fragment when responding to a user query, and potentially show it in the context of the original source document; an LLM-generated embedding vector of the source text fragment; and answers to each of a plurality of determinative questions.

The created index can be stored in generic tables within a standard relational database, storing the Boolean, numeric and text responses in indexed columns of the appropriate type.

This approach allows a body of text of any size to be processed using the LLMs using a total token count (a proxy for both cost, network usage, and time) that is proportional to the total size of the imported text and the number and length of the determinative questions. Following the creation of the index, any number of queries may be evaluated without further LLM usage, significantly reducing cost, network usage and time.

The query process which uses the index that is created as a result of the above-described steps, is now described.

Using the index, the system is then capable of finding all text fragments that match criteria, by expressing the query in terms of queries on the indexed columns of the underlying relational tables. Queries may refer to any response given by the LLM to the pre-determined determinative questions, without the need to query the LLM sub-system at all during the query.

This advantageously enables any number of queries to be run against the data set without incurring any additional network usage or time delay.

For each event found by the query using the index, the system can locate the text in the original source document, and optionally show that text to the user in its original context, due to the pointer contained within each index entry.

1. A computer-implemented method for generating chronologies, the method comprising:
receiving one or more pieces of digital content, and for each piece of digital content:
extracting core content from the piece of digital content;
processing the core content using a pre-trained neural network model to extract one or more pieces of event data from the piece of digital content, the pieces of event data being linked to an event;
combining a plurality of pieces of event data from the one or more pieces of digital content to generate a database of events;
generating a chronology using the database of events.

2. The method according to claim 1, the method further comprising, for each piece of digital content:
extracting internal metadata from the piece of digital content;
combining the extracted internal metadata with an external metadata of the piece of digital content to generate a complete set of metadata for the piece of digital content;
wherein optionally the step of processing the core content to extract the one or more pieces of event data further comprises processing both the core content and the complete set of metadata using the pre-trained neural network model.

3. The method according to claim 1, wherein the one or more pieces of digital content comprise one or more of: an email, an image file, a text document, a spreadsheet, a written statement, a video file, an audio file, a scanned document and/or a PDF file.

4. The method according to claim 3, wherein:
the one or more pieces of digital content comprises the video file and the step of extracting the core content from the piece of digital content comprises generating a transcript of the video file using a first machine learning model; and/or
the one or more pieces of digital content comprises the audio file and the step of extracting the core content from the piece of digital content comprises generating a transcript of the audio file using a second machine learning model.

5. The method according to claim 3, wherein: the one or more pieces of digital content comprises the image file, the scanned document or the PDF file and the step of extracting the core content from the piece of digital content comprises applying Optical Character Recognition software to the digital content.

6. The method according to claim 1, wherein the core content comprises text information and/or context information.

7. The method according to claim 4, wherein the core content comprises text information and/or context information and the text information comprises the transcript of the video file and/or the transcript of the audio file.

8. The method according to claim 3, wherein the core content comprises text information and/or context information and the one or more pieces of digital content comprises the email, the text file or the spreadsheet and the step of extracting the core content from the piece of digital content comprises harvesting the text information directly from the digital content.

9. The method according to claim 6, wherein prior to processing the core content, the method further comprises:
slicing the text information into two or more smaller text portions; and optionally
associating one or more fragments of the context information with each of the two or more smaller text portions.

10. The method according to claim 1, further comprising:
supplying a prompt to the pre-trained neural network model, the prompt comprising an indication of:
types of events to be extracted; and/or
type of information to be extracted from each type of event; and/or
examples of the information to be extracted from each type of event.

11. The method according to claim 10, further comprising:
applying restrictions associated with the prompt when processing the core content using the pre-trained neural network model.

12. The method according to claim 10, further comprising:
receiving a request comprising a user-specified guidance, the request comprising additional information relating to events which are to be investigated; and
determining the prompt based on the user-specified guidance.

13. The method according to claim 1, wherein the one or more pieces of event data comprises a description of the event and/or time of the event and/or location of the event and/or parties involved in the event and/or entities involved in the event.

14. The method according to claim 13, wherein the time of the event comprises an absolute time of the event and/or a relative time of the event.

15. The method according to claim 14, further comprising: converting the relative time of the event to the absolute time of the event by applying natural language processing techniques to the one or more pieces of event data.

16. The method according to claim 1, further comprising analyzing the database of events to group a plurality of smaller, related or equivalent events into a larger event.

17. The method according to claim 16, wherein the one or more pieces of event data comprises a description of the event and/or time of the event and/or location of the event and/or parties involved in the event and/or entities involved in the event, and
grouping the plurality of smaller, related or equivalent events into a larger event comprises producing a set of potentially matching events by:
searching the plurality of pieces of event data for potentially matching events using fuzzy string matching and embedding information; and/or
identifying similar times of the events in the database of events.

18. The method according to claim 17, wherein producing a set of potentially matching events further comprises, for each set of potentially matching events:
determining whether the events are related or equivalent using a third machine learning model; and optionally
upon determining that the events are related, identifying a type of relationship between the events using the third machine learning model.

19. The method according to claim 1, further comprising:
providing a visual representation of the chronology by generating a list, a timeline, a fishbone diagram and/or a knowledge graph based on the chronology.

20. The method according to claim 1, further comprising:
filtering the chronology by: a type of event, parties involved in the event, a location of the event, a time range within which the one or more events took place, and/or a keyword.

21. The method according to claim 1, further comprising:
attaching a reference to each event in the chronology, the reference connecting each event to the one or more pieces of digital content.

22. The method according to claim 1, further comprising manually adding, removing, reordering, and/or amending one or more of the events in the chronology.

23. A computer program comprising instructions which, when the program is executed by a computer, cause the computer to perform a method in accordance with claim 1.

24. A computer-readable medium comprising instructions that, when executed by one or more processors, cause an apparatus comprising the one or more processors to perform a method in accordance with claim 1.
